(19) United States
(12) Patent Application Publication
(10) Pub. No.: US 2026/0051239 A1
(43) Pub. Date: Feb. 19, 2026

(54) ACCIDENT EARLY WARNING METHOD, DEVICE, STORAGE MEDIUM, CONTROLLER AND VEHICLE

(71) Applicant: Bosch Automotive Products (Suzhou) Co. Ltd., Suzhou (CN)

(72) Inventors: Wei Qiu, Suzhou (CN); Yu Xia, Suzhou (CN); Ying Zhang, Suzhou (CN)

(21) Appl. No.: 19/244,673

(22) Filed: Jun. 20, 2025

(30) Foreign Application Priority Data
Jun. 20, 2024 (CN) 202410797940.1

(51) Int. Cl. G08B 25/14; G01C 21/36; G07C 5/00; G07C 5/02

(52) U.S. Cl. CPC G08B 25/14; G01C 21/3691; G07C 5/008; G07C 5/02

(57) ABSTRACT

The present disclosure provides an accident warning method, apparatus, storage medium, controller, and vehicle. According to the accident warning method proposed by the present disclosure, in response to detecting that the host vehicle has been involved in a traffic accident, accident warning information corresponding to the traffic accident is generated, wherein the accident warning information comprises the accident location associated with the traffic accident. The accident warning information is sent to a navigation server, such that the navigation server sends the accident warning information to vehicles to be warned that are about to pass through the accident location. In this way, vehicles approaching the accident location can be warned in advance when a traffic accident occurs, thereby improving driving safety.

### TECHNICAL FIELD

The present disclosure relates to the technical field of vehicle control, and in particular, to an accident warning method, apparatus, storage medium, controller, and vehicle.

### PRIOR ART

In related technologies, after a serious traffic accident occurs on a road, the involved vehicle is unable to leave the accident site within a short period of time and can only call for rescue assistance. Only after the accident vehicle is towed away from the accident site and the road is cleared can normal, unobstructed traffic be restored.

However, during the period from the occurrence of the accident to the removal of the accident vehicle from the accident site, vehicles passing through the accident site are prone to secondary traffic accidents with the accident vehicle, and traffic congestion is also likely to occur.

### SUMMARY OF THE INVENTION

Based on the foregoing, the present disclosure provides an accident warning method, apparatus, storage medium, vehicle controller, and vehicle. By employing the accident warning method described herein, accident warning information can be promptly sent to vehicles that are about to pass through the accident location after a traffic accident occurs, thereby providing timely warnings, preventing more severe secondary accidents, and enhancing driving safety.

In one aspect, the present disclosure provides an accident warning method, comprising:
in response to detecting that the host vehicle has been involved in a traffic accident, generating accident warning information corresponding to the traffic accident, wherein the accident warning information comprises the accident location corresponding to the traffic accident;
sending the accident warning information to a navigation server, so that the navigation server sends the accident warning information to vehicles to be warned that are about to pass through the accident location.

Further, in some embodiments, the method further comprises:
monitoring vehicle acceleration and/or roll angular velocity;
determining that the host vehicle has been involved in a traffic accident when the vehicle acceleration exceeds a preset acceleration threshold and/or the roll angular velocity exceeds a preset angular velocity threshold.

Further, in some embodiments, the accident location is determined based on satellite positioning technology at the time the traffic accident occurs.

Further, in some embodiments, the accident warning information further comprises one or more of the following: accident images, vehicle attitude, cabin occupant status, collision type, and airbag status;
wherein the accident images are acquired by an onboard camera upon detecting that the host vehicle has been involved in a traffic accident;
the cabin occupant status is determined based on the response of the occupant to a rescue call, the rescue call being automatically triggered and dialed upon detecting the occurrence of a traffic accident;
the vehicle attitude is determined according to the lateral acceleration and vertical acceleration after detecting that the host vehicle has been involved in a traffic accident;
the airbag status is obtained after detecting that the host vehicle has been involved in a traffic accident;
the collision type is determined according to the vehicle acceleration and roll angular velocity at the time of the accident.

Further, in some embodiments, the accident warning information further comprises accident severity;
wherein the accident severity is determined based on one or more of the following: the vehicle acceleration at the time of the accident, the vehicle attitude, the cabin occupant status, and the airbag status.

Further, in some embodiments, the method further comprises:
generating vehicle rescue information based on the vehicle attitude, the cabin occupant status, and the airbag status, and sending the rescue information to a rescue center.

In another aspect, the present disclosure provides an accident warning method applied to a navigation server, comprising:
receiving accident warning information sent by an accident vehicle;
determining, according to the accident location in the accident warning information, vehicles to be warned that are about to pass through the accident location;
sending the accident warning information to the vehicles to be warned.

Further, in some embodiments, receiving the accident warning information sent by accident vehicles comprises:
receiving accident warning information sent respectively by a plurality of accident vehicles;
determining at least two accident warning information items with the same accident location based on the accident location in each accident warning information;
merging the at least two accident warning information items to obtain merged accident warning information;
sending the accident warning information to the vehicles to be warned comprises:
sending the merged accident warning information to the vehicles to be warned.

Further, in some embodiments, determining vehicles to be warned that are about to pass through the accident location based on the accident location in the accident warning information comprises:
for vehicles with planned navigation routes, regarding vehicles whose navigation routes pass through the accident location as the vehicles to be warned;
for vehicles without planned navigation routes, determining vehicles located on the same road segment as the accident location based on the vehicle's positioning location as the vehicles to be warned.

In another aspect, the present disclosure provides an accident warning apparatus, comprising:
an information generation module, configured to, in response to detecting that the host vehicle has been involved in a traffic accident, generate accident warning information corresponding to the traffic accident, wherein the accident warning information comprises the accident location corresponding to the traffic accident;
an information transmission module, configured to send the accident warning information to a navigation server, so that the navigation server sends the accident warning information to vehicles to be warned that are about to pass through the accident location.

In another aspect, the present disclosure provides an accident warning apparatus, comprising:
an information receiving module, configured to receive accident warning information sent by an accident vehicle;
a vehicle determination module, configured to determine, according to the accident location in the accident warning information, vehicles to be warned that are about to pass through the accident location;
a warning transmission module, configured to send the accident warning information to the vehicles to be warned.

In another aspect, the present invention provides a storage medium stored with a computer program adapted for loading by a processor and performing the steps of the above described method.

In another aspect, the present invention also provides for a vehicle controller comprising: a processor and memory; wherein the memory stores a computer program adapted to be loaded by the processor and to perform the steps of the method described above.

In another aspect, the present disclosure further provides a vehicle comprising the above accident warning apparatus or vehicle controller.

According to the accident warning method provided by the present disclosure, in response to detecting that the host vehicle has been involved in a traffic accident, accident warning information corresponding to the traffic accident is generated, wherein the accident warning information comprises the accident location corresponding to the traffic accident. The accident warning information is sent to the navigation server via the navigation system, such that the navigation server transmits the accident warning information to vehicles to be warned that are about to pass through the accident location. By providing accident warnings to vehicles about to pass through the accident location, potential secondary traffic accidents can be avoided, thereby improving driving safety.

It will be understood that the content described in the Summary of the Invention is not intended to limit key or important features of the examples of the present disclosure, nor is it intended to limit the scope of the present invention. Other features of the present invention will become readily understood by the following description.

### BRIEF DESCRIPTION OF THE DRAWINGS

FIG. 1 is a system architecture diagram of an accident warning method provided in an embodiment of the present disclosure;

FIG. 2 is a flowchart illustrating an accident warning method provided in an embodiment of the present disclosure;

FIG. 3 is a flowchart illustrating an accident warning method provided in an embodiment of the present disclosure;

FIG. 4 is a structural schematic diagram of an accident warning apparatus provided in an embodiment of the present disclosure;

FIG. 5 is a structural schematic diagram of an accident warning apparatus provided in an embodiment of the present disclosure;

FIG. 6 is a structural schematic diagram of an accident warning apparatus provided in an embodiment of the present disclosure;

FIG. 7 is a structural schematic diagram of a vehicle controller provided in an embodiment of the present disclosure.

### DETAILED DESCRIPTION OF THE EMBODIMENTS

In order to make the objects, technical solutions and advantages of the present invention clearer, the technical solutions of the present invention will be clearly and completely described below in combination with the specific embodiments of the present invention and the corresponding drawings. Obviously, the embodiments described are only part of the embodiments of the present invention, not all of them. Based on the embodiments in the present invention, all other embodiments obtained by one of ordinary skill in the art without creative work fall within the protection scope of the present invention.

In one or more descriptions of the embodiments of the present invention, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first”, “second”, etc. may refer to different or the same object. Other explicit and implicit definitions may be included below.

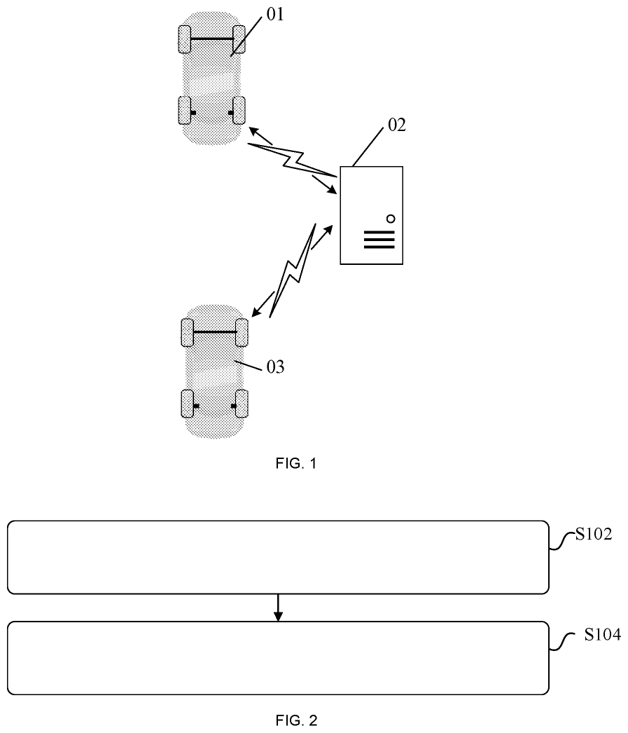

Referring to FIG. 1, which is a system architecture diagram of an accident warning method provided in an embodiment of the present disclosure. As shown in FIG. 1, the system architecture comprises a host vehicle 01, a navigation server 02, and vehicles to be warned 03.

When the host vehicle 01 is involved in a traffic accident, the host vehicle 01 transmits accident warning information containing the accident location to the navigation server 02. The navigation server 02 identifies vehicles to be warned 03 that are about to pass through the accident location and transmits the accident warning information to those vehicles 03. This enables the vehicles to be warned 03 to be informed in advance of a traffic accident ahead, thereby avoiding potential secondary accidents and improving driving safety.

Referring to FIG. 1 and FIG. 2, FIG. 2 is a flowchart illustrating an accident warning method provided in an embodiment of the present disclosure. A detailed description of the process illustrated in FIG. 2 is provided below. The accident warning method may specifically comprise the following steps:

Step S102, in response to detecting that the host vehicle has been involved in a traffic accident, generating accident warning information corresponding to the traffic accident, wherein the accident warning information comprises the accident location corresponding to the traffic accident;

During vehicle operation, the driving state of the vehicle is monitored in real time. Upon detecting that the vehicle has been involved in a traffic accident, accident warning information containing the accident location is generated. The accident location may be determined based on satellite positioning technology.

It should be noted that the host vehicle is pre-equipped with a positioning module, which can receive positioning signals sent by satellites. Based on a plurality of positioning signals received from different satellites, the vehicle's location can be calculated using the principle of triangulation. In the embodiment of the present disclosure, when the host vehicle is involved in a traffic accident, the current location of the vehicle is determined using satellite positioning technology, and this location is used as the accident location to generate accident warning information containing the accident location.

In one feasible implementation, whether a traffic accident has occurred can be determined by monitoring the vehicle's acceleration and roll angular velocity information. When a collision occurs, the vehicle's acceleration increases rapidly. By monitoring the vehicle's acceleration, if the acceleration exceeds a preset acceleration threshold, it can be determined that a collision-type traffic accident has occurred. When a rollover occurs, the vehicle's roll angular velocity increases beyond a certain threshold. By monitoring the roll angular velocity, if it exceeds a preset angular velocity threshold, it can be determined that a rollover-type traffic accident has occurred.

Further optionally, by monitoring the vehicle's roll angular velocity and integrating it over a preset period, an angle can be obtained. If the integrated angle exceeds a preset angle threshold and the roll angular velocity exceeds the preset angular velocity threshold, it can be determined that a rollover-type traffic accident has occurred.

It is understood that by integrating the roll angular velocity over a certain period, the angle of vehicle roll during that period can be obtained. If the angle exceeds a preset angle threshold, it is determined that a rollover-type traffic accident has occurred.

The vehicle's acceleration and roll angular velocity can be measured by corresponding sensors.

Step S104: sending the accident warning information to a navigation server, so that the navigation server sends the accident warning information to vehicles to be warned that are about to pass through the accident location.

After generating accident warning information containing the accident location, the information is sent to the navigation server, which then forwards it to vehicles to be warned that are about to pass through the accident location, thereby providing accident warnings to those vehicles.

The navigation server refers to a backend system or service platform that provides navigation services and is primarily responsible for processing various data and requests related to navigation. The navigation server may plan navigation routes for vehicles based on their destinations and, with authorization, may obtain real-time location information of vehicles.

In one feasible implementation, the accident warning information may be sent to the navigation server via a vehicle networking system. The vehicle networking system may transmit the accident warning information to the navigation server via terrestrial signal base stations or satellite communication.

In the embodiment of the present disclosure, if a vehicle is involved in a traffic accident, in response to detecting the occurrence of a traffic accident in the host vehicle, accident warning information including the accident location corresponding to the traffic accident is generated and sent to the navigation server. The navigation server then transmits the accident warning information to vehicles to be warned that are about to pass through the accident location, thereby providing accident warnings to those vehicles. By warning vehicles that are about to pass through the accident location, potential secondary accidents can be avoided, and driving safety can be improved.

In one embodiment, detecting whether the host vehicle has been involved in a traffic accident specifically comprises: monitoring vehicle acceleration and/or roll angular velocity in a real-time manner, determining that the host vehicle has been involved in a traffic accident when the vehicle acceleration exceeds a preset acceleration threshold and/or the roll angular velocity exceeds a preset angular velocity threshold.

When a collision occurs, the vehicle's acceleration increases rapidly at the moment of impact. By monitoring the vehicle's acceleration, if the acceleration exceeds a preset acceleration threshold, it can be determined that a collision-type traffic accident has occurred. When a rollover occurs, the vehicle's roll angular velocity increases rapidly at the moment of rollover. By monitoring the roll angular velocity, if it exceeds a preset angular velocity threshold, it can be determined that a rollover-type traffic accident has occurred.

Furthermore, the vehicle's acceleration comprises longitudinal acceleration, lateral acceleration, and vertical acceleration. The direction of the collision can be determined based on changes in acceleration in different directions. If the longitudinal acceleration exceeds a preset threshold, it indicates a possible rear-end collision or being rear-ended; if the lateral acceleration exceeds the threshold, it indicates a side impact; if the vertical acceleration exceeds the threshold, it indicates a possible crushing incident.

Further, by monitoring the vehicle's roll angular velocity and integrating it over a preset period, an angle can be obtained. If the integrated angle exceeds a preset angle threshold and the roll angular velocity exceeds the preset angular velocity threshold, it can be determined that a rollover-type traffic accident has occurred.

Additionally, the direction of rollover can be determined based on the direction of the roll angular velocity.

In one embodiment, the accident warning information further comprises one or more of the following: accident images, vehicle attitude, cabin occupant status, collision type, and airbag status.

Wherein the accident images are acquired by an onboard camera upon detecting that the host vehicle has been involved in a traffic accident.

Specifically, when a traffic accident is detected, the onboard camera is activated to capture images of the accident scene at the time of and after the accident, and the accident warning information is generated based on the accident images.

The cabin occupant status is determined based on the response of the occupants to a rescue call, the rescue call being automatically triggered and dialed upon detecting the occurrence of a traffic accident.

Specifically, after detecting a traffic accident, the vehicle's rescue function automatically triggers a rescue call. Once the call is connected, the conversation between the cabin occupants and the rescue call is recorded, and the occupant status is determined based on their response. For example, if the occupants are communicating normally, it indicates that they may not have suffered serious injuries and remain conscious. If there is no response, it may indicate that the occupants are unconscious.

The vehicle attitude is determined according to the lateral acceleration and vertical acceleration after detecting that the host vehicle has been involved in a traffic accident.

Specifically, upon detecting that a vehicle has been involved in a traffic accident, the vehicle's attitude is determined based on the lateral acceleration and vertical acceleration at the time the vehicle comes to a stop.

The vehicle attitude may comprise a normal attitude, left rollover attitude, right rollover attitude, and inverted attitude. Wherein, the normal attitude refers to the state in which the vehicle's wheels are in contact with the ground; the left rollover attitude refers to the state in which the left side of the vehicle is in contact with the ground; the right rollover attitude refers to the state in which the right side of the vehicle is in contact with the ground; and the inverted attitude refers to the state in which the top of the vehicle is in contact with the ground.

It should be noted that, when the vehicle is in the normal attitude with its wheels on the ground, the gravitational force causes a detected vertical acceleration of 1G magnitude directed toward the underside of the vehicle. If the vehicle is in the left rollover attitude with its left side on the ground, the gravitational force results in a detected lateral acceleration of 1G magnitude directed toward the left side of the vehicle body. If the vehicle is in the right rollover attitude with its right side on the ground, the gravitational force results in a detected lateral acceleration of 1G magnitude directed toward the right side of the vehicle body. If the vehicle is in the inverted attitude with its roof on the ground, the gravitational force results in a detected vertical acceleration of 1G magnitude directed toward the roof of the vehicle.

The airbag status is obtained after detecting that the host vehicle has been involved in a traffic accident.

Specifically, upon detecting that the vehicle has been involved in a traffic accident, the airbag status is acquired, wherein the airbag status is configured to indicate whether the airbag has been deployed.

The collision type is determined according to the vehicle acceleration and roll angular velocity at the time of the accident.

If the vehicle's acceleration at the time of the accident exceeds a preset acceleration threshold, the accident type is determined to be a collision accident; if the roll angular velocity at the time of the accident exceeds a preset angular velocity threshold, the accident type is determined to be a rollover accident; if both the vehicle's acceleration and roll angular velocity at the time of the accident exceed their respective preset thresholds, the accident type is determined to be a collision-rollover accident.

Optionally, by monitoring the vehicle's roll angular velocity and integrating it over a preset period, an angle can be obtained. If the integrated angle exceeds a preset angle threshold and the roll angular velocity exceeds the preset angular velocity threshold, it can be determined that a rollover-type traffic accident has occurred.

Furthermore, the accident warning information may also comprise the accident severity, which is determined based on one or more of the following: the vehicle's acceleration at the time of the accident, vehicle attitude, cabin occupant status, and airbag status.

Specifically, the vehicle's acceleration at the time of the accident can, to some extent, reflect the severity of the collision; the greater the acceleration, the more severe the collision. The accident severity is higher when the vehicle attitude is a rollover or inverted attitude than when it is in the normal attitude. The accident severity is higher when the cabin occupant status is conscious than when the occupant status is unconscious. The accident severity is higher when the airbag status is deployed than when the airbag status is not deployed.

In a feasible embodiment, different levels of accident severity may be set according to various combinations of the vehicle's acceleration at the time of the accident, vehicle attitude, cabin occupant status, and airbag status. Accordingly, upon the occurrence of a traffic accident, the corresponding accident severity level may be determined based on these parameters.

In a feasible embodiment, the change in vehicle speed at the time of the accident can be obtained by integrating the vehicle's acceleration over time during the collision. The accident severity level can then be determined based on the change in vehicle speed, vehicle attitude, cabin occupant status, and airbag status.

In one embodiment, vehicle rescue information is generated based on the vehicle attitude, cabin occupant status, and airbag status, and the rescue information is sent to a rescue center.

The rescue center may be a department or organization dedicated to emergency rescue in traffic accidents, capable of providing medical assistance to occupants and road rescue for the accident vehicle.

In the embodiments of the present disclosure, after a traffic accident occurs, vehicle rescue information is generated based on the vehicle attitude, cabin occupant status, and airbag status. The vehicle attitude assists the rescue center in determining whether specialized rescue equipment is needed to adjust the vehicle's position (for example, if the vehicle has rolled over, a forklift may be required to rotate the vehicle 180° to facilitate road rescue). The cabin occupant status assists the rescue center in determining whether medical rescue is required, and the airbag status assists in assessing the accident severity. By automatically and promptly sending vehicle rescue information-comprising vehicle attitude, cabin occupant status, and airbag status-to the rescue center after a traffic accident, timely and effective rescue may be provided to the accident vehicle and its occupants.

In one embodiment, in response to the cabin occupant status being unconscious, a medical rescue call is automatically placed to request medical assistance, and the accident location is automatically reported during the call.

In one embodiment, referring to FIG. 3, which is a flowchart illustrating an accident warning method provided in an embodiment of the present disclosure. This accident warning method is applied to a navigation server, and comprises the following steps:

S202: receiving accident warning information sent by an accident vehicle;

The navigation server receives the accident warning information sent by the accident vehicle, wherein the accident warning information at least comprises the accident location where the accident vehicle has been involved in an accident.

Step S204: determining, according to the accident location in the accident warning information, vehicles to be warned that are about to pass through the accident location;

After receiving the accident warning information from the accident vehicle, the navigation server determines, based on the accident location in the accident warning information, the vehicles to be warned that are about to pass through the accident location.

The navigation server refers to a backend system or service platform that provides navigation services and is primarily responsible for processing various data and requests related to navigation. The navigation server may plan navigation routes for vehicles based on their destinations and, with authorization, may obtain real-time location information of vehicles.

In a feasible embodiment, the navigation server identifies vehicles whose planned navigation routes pass through the accident location and designates these vehicles as vehicles to be warned.

Further, the navigation server may obtain the real-time location of vehicles and
determine those vehicles located on the same road segment as the accident location as vehicles to be warned.

Step S206: sending the accident warning information to the vehicles to be warned.

After determining the vehicles to be warned, the accident warning information is sent to these vehicles.

In a feasible embodiment, the navigation server transmits the accident warning information to the vehicles to be warned via terrestrial base stations or satellite communication.

In embodiments of the present disclosure, after the navigation server receives accident warning information sent by an accident vehicle, it determines, based on the accident location contained in the warning information, the vehicles to be warned that are about to pass through the accident location, and subsequently transmits the accident warning information to these vehicles to be warned. This enables advance accident warning for the vehicles to be warned, thereby preventing potential secondary traffic accidents and improving driving safety.

In one embodiment, if a plurality of accident vehicles are involved in a traffic accident, the navigation server may receive accident warning information sent respectively by each accident vehicle. Specifically: The navigation server receives accident warning information sent respectively by a plurality of accident vehicles, determines, based on the accident location in each piece of accident warning information, at least two accident warning information entries with the same accident location, and merges at least two such accident warning information entries to obtain merged accident warning information. The merged accident warning information is then sent to the vehicles to be warned, thereby providing advance warning to these vehicles, preventing potential secondary traffic accidents, and improving driving safety.

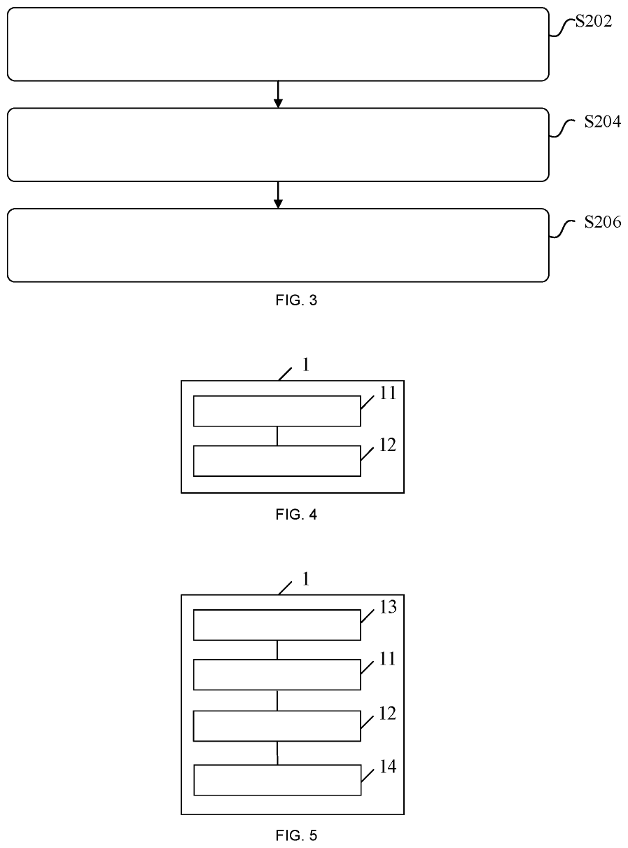

Referring to FIG. 4, which is a structural schematic diagram of an accident warning apparatus provided in an embodiment of the present disclosure. As shown in FIG. 4, the accident warning apparatus 1 may be implemented in software, hardware, or a combination thereof, and may constitute all or part of a vehicle controller. According to some embodiments, the accident warning apparatus 1 comprises an information generation module 11 and an information transmission module 12, specifically including:
an information generation module 11, configured to, in response to detecting that the host vehicle has been involved in a traffic accident, generate accident warning information corresponding to the traffic accident, wherein the accident warning information comprises the accident location corresponding to the traffic accident;
an information transmission module 12, configured to send the accident warning information to a navigation server, so that the navigation server sends the accident warning information to vehicles to be warned that are about to pass through the accident location.

Optionally, please refer to FIG. 5. The accident warning apparatus may further comprise an accident detection module 13, specifically configured to:
monitor vehicle acceleration and/or roll angular velocity;
determine that the host vehicle has been involved in a traffic accident when the vehicle acceleration exceeds a preset acceleration threshold and/or the roll angular velocity exceeds a preset angular velocity threshold.

Optionally, the accident location is determined based on satellite positioning technology at the time the traffic accident occurs.

Optionally, the accident warning information further comprises one or more of the following: the accident images, vehicle attitude, cabin occupant status, collision type, and airbag;
wherein the accident images are acquired by an onboard camera upon detecting that the host vehicle has been involved in a traffic accident;
the cabin occupant status is determined based on the response of the occupant to a rescue call, the rescue call being automatically triggered and dialed upon detecting the occurrence of a traffic accident;
the vehicle attitude is determined according to the lateral acceleration and vertical acceleration after detecting that the host vehicle has been involved in a traffic accident;
the airbag status is obtained after detecting that the host vehicle has been involved in a traffic accident;
the collision type is determined according to the vehicle acceleration and roll angular velocity at the time of the accident.

Optionally, the accident warning information further comprises accident severity;
wherein the accident severity is determined based on one or more of the following: the vehicle acceleration at the time of the accident, the vehicle attitude, the cabin occupant status, and the airbag status.

Optionally, as shown in FIG. 5, the apparatus further comprises a rescue assistance module 14, specifically configured to:
generate vehicle rescue information based on the vehicle attitude, the cabin occupant status, and the airbag status, and sending the rescue information to a rescue center.

The above device embodiments correspond to the embodiment of the method. For specific description, please refer to the description of the embodiment of the method, which will not be repeated here. The device embodiment is obtained based on the corresponding method embodiment and has the same technical effect as the corresponding method embodiment. Refer to the corresponding method embodiment for the specific description.

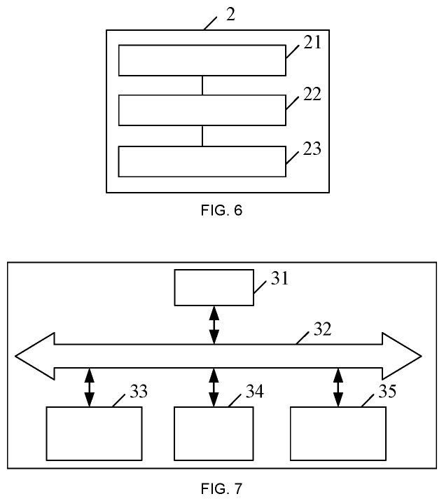

Referring to FIG. 6, which is a structural schematic diagram of an accident warning apparatus provided in an embodiment of the present disclosure. As shown in FIG. 6, the accident warning apparatus 2 may be implemented in software, hardware, or a combination thereof, and may constitute all or part of a navigation server. According to some embodiments, the accident warning apparatus 2 comprises an information receiving module 21, a vehicle determination module 22, and a warning transmission module 23, specifically including:
an information receiving module 21, configured to receive accident warning information sent by an accident vehicle;
a vehicle determination module 22, configured to determine, according to the accident location in the accident warning information, vehicles to be warned that are about to pass through the accident location;
a warning transmission module 23, configured to send the accident warning information to the vehicles to be warned.

Optionally, the information receiving module 21 is specifically configured to:
receive accident warning information sent respectively by a plurality of accident vehicles;
determine at least two accident warning information items with the same accident location based on the accident location in each accident warning information;
merge the at least two accident warning information items to obtain merged accident warning information;

The warning transmission module 23 is specifically configured to:
send the merged accident warning information to the vehicles to be warned.

Optionally, the vehicle determination module 22 is specifically configured to:
for vehicles with planned navigation routes, regard vehicles whose navigation routes pass through the accident location as the vehicles to be warned;
for vehicles without planned navigation routes, determine vehicles located on the same road segment as the accident location based on the vehicle's positioning location as the vehicles to be warned.

The above device embodiments correspond to the embodiment of the method. For specific description, please refer to the description of the embodiment of the method, which will not be repeated here. The device embodiment is obtained based on the corresponding method embodiment and has the same technical effect as the corresponding method embodiment. Refer to the corresponding method embodiment for the specific description.

The present disclosure further provides a storage medium, which may store multiple instructions, the instructions being suitable for loading and execution by a processor to implement the accident warning method as described in the above embodiments. The specific execution process may refer to the detailed descriptions in the above embodiments and will not be repeated here.

The present disclosure further provides a computer program product, which stores at least one instruction, the at least one instruction being loaded and executed by the processor to implement the accident warning method as described in the above embodiments. The specific execution process may refer to the detailed descriptions in the above embodiments and will not be repeated here.

In one embodiment, the present disclosure further provides a schematic structural diagram of a vehicle controller as shown in FIG. 7. As shown in FIG. 7, at the hardware level, the vehicle controller comprises a processor 31, an internal bus 32, a network interface 33, a memory 34, and a non-volatile storage 35, and may also comprise other hardware required for business operations. The vehicle controller may be disposed in a vehicle, wherein the processor 31 reads the corresponding computer program from the non-volatile storage 35 into memory for execution, so as to implement the aforementioned accident warning method.

In one embodiment, the present disclosure further provides a vehicle, which may comprise the aforementioned accident warning apparatus or vehicle controller, so as to execute the accident warning method via the accident warning apparatus or vehicle controller to improve driving safety.

Finally, the various embodiments in the present invention are described in a progressive manner. The same parts of each embodiment can be seen from each other. Each embodiment focuses on different aspects than the other embodiments. In particular, for system embodiments, since it is substantially similar to the method embodiments, the description is relatively simple, and relevant aspects are only described in part of the method embodiments.

The foregoing is merely the embodiments of the invention and is not intended to limit the invention. Various changes and variations may be made to the present invention to those skilled in the art. Any modifications, equivalent substitutions, improvements, etc. made within the spirit and principles of the present invention shall be included within the scope of the claims of the present invention.

1. An accident warning method, applied at a vehicle end, comprising:
in response to detecting that the host vehicle has been involved in a traffic accident, generating accident warning information corresponding to the traffic accident, wherein the accident warning information comprises the accident location corresponding to the traffic accident;
sending the accident warning information to a navigation server, so that the navigation server sends the accident warning information to vehicles to be warned that are about to pass through the accident location.

2. The method according to claim 1, further comprising:
monitoring vehicle acceleration and/or roll angular velocity;
determining that the host vehicle has been involved in a traffic accident when the vehicle acceleration exceeds a preset acceleration threshold and/or the roll angular velocity exceeds a preset angular velocity threshold.

3. The method according to claim 1, wherein the accident location is determined based on satellite positioning technology at the time when the traffic accident occurs.

4. The method according to claim 1, wherein the accident warning information further comprises one or more of the following: accident images, vehicle attitude, cabin occupant status, collision type, and airbag status;
wherein the accident images are acquired by an onboard camera upon detecting that the host vehicle has been involved in a traffic accident;
the cabin occupant status is determined based on the response of the occupant to a rescue call, the rescue call being automatically triggered and dialed upon detecting the occurrence of a traffic accident;
the vehicle attitude is determined according to the lateral acceleration and vertical acceleration after detecting that the host vehicle has been involved in a traffic accident;
the airbag status is obtained after detecting that the host vehicle has been involved in a traffic accident;
the collision type is determined according to the vehicle acceleration and roll angular velocity at the time of the accident.

5. The method according to claim 4, wherein the accident warning information further comprises accident severity;
wherein the accident severity is determined based on one or more of the following: the vehicle acceleration at the time of the accident, the vehicle attitude, the cabin occupant status, and the airbag status.

6. The method according to claim 4, further comprising:
generating vehicle rescue information based on the vehicle attitude, the cabin occupant status, and the airbag status, and sending the rescue information to a rescue center.

7. An accident warning method, applied at a navigation server, comprising:
receiving accident warning information sent by an accident vehicle;
determining, according to the accident location in the accident warning information, vehicles to be warned that are about to pass through the accident location;
sending the accident warning information to the vehicles to be warned.

8. The method according to claim 7, wherein receiving accident warning information sent by the accident vehicle comprises:
receiving accident warning information sent respectively by a plurality of accident vehicles;
determining at least two accident warning information items with the same accident location based on the accident location in each accident warning information;
merging the at least two accident warning information items to obtain merged accident warning information;
sending the accident warning information to the vehicles to be warned comprises:
sending the merged accident warning information to the vehicles to be warned.

9. The method according to claim 7, wherein determining vehicles to be warned that are about to pass through the accident location according to the accident location in the accident warning information comprises:
for vehicles with planned navigation routes, regarding vehicles whose navigation routes pass through the accident location as the vehicles to be warned;
for vehicles without planned navigation routes, determining vehicles located on the same road segment as the accident location based on the vehicle's positioning location as the vehicles to be warned.

10. An accident warning apparatus, comprising:
an information generation module, configured to, in response to detecting that the host vehicle has been involved in a traffic accident, generate accident warning information corresponding to the traffic accident, wherein the accident warning information comprises the accident location corresponding to the traffic accident;
an information transmission module, configured to send the accident warning information to a navigation server, so that the navigation server sends the accident warning information to vehicles to be warned that are about to pass through the accident location.

11. An accident warning apparatus, comprising:
an information receiving module, configured to receive accident warning information sent by an accident vehicle;
a vehicle determination module, configured to determine, according to the accident location in the accident warning information, vehicles to be warned that are about to pass through the accident location;
a warning transmission module, configured to send the accident warning information to the vehicles to be warned.

12. A storage medium, on which a computer program is stored, wherein the computer program, when executed by a processor, implements the steps of the method of any one of claims 1 to 6 or 7 to 9.

13. A vehicle controller, comprising: a processor and a memory; wherein the memory stores a computer program, the computer program being adapted to be loaded and executed by the processor to implement the steps of the method of any one of claims 1 to 6 or 7 to 9.

14. A vehicle, comprising the accident warning apparatus according to claim 10 or the vehicle controller according to claim 13.
